(19) United States
(12) Patent Application Publication
(10) Pub. No.: US 2020/0093203 A1
(43) Pub. Date: Mar. 26, 2020

(54) INDUSTRIAL GLOVE COATED WITH POLYUREA RESIN COMPOSITION AND SILICONE RESIN, AND METHOD OF MANUFACTURING THE SAME

(71) Applicants: Jong Jin HONG, Gyeongsangnam-do (KR); Young Woo KIM, Seoul (KR); TOUCH GREEN CO., LTD., Chungcheongbuk-do (KR)

(72) Inventors: Jong Jin HONG, Gyeongsangnam-do (KR); Young Woo KIM, Seoul (KR); Seong Ho YEOM, Jeollanam-do (KR)

(21) Appl. No.: 16/139,899

(22) Filed: Sep. 24, 2018

(30) Foreign Application Priority Data
Sep. 20, 2018 (KR) 10-2018-0113020

(51) Int. Cl. A41D 19/00; A41D 19/015; C08L 75/02; C08L 83/04; C08K 5/09

(52) U.S. Cl. CPC A41D 19/0058; A41D 19/01529; C08L 75/02; A41D 2600/20; C08K 5/09; A41D 2500/54; C08L 83/04

(57) ABSTRACT

Industrial glove coated with polyurea resin composition and silicone resin, and a method of manufacturing the industrial glove are provided. The industrial glove comprises: a glove; a first coating film disposed on the glove and comprising a polyurea resin; and a second coating film disposed on the first coating film and comprising a silicone resin, wherein the first coating film comprises: an inner film layer formed such that an inner skin of the glove is partially impregnated with at least a part of the polyurea resin, but the at least a part of the polyurea resin does not permeate into an inner surface of the glove; and a coating layer formed of the remainder of the polyurea resin on an outer surface of the glove.

### PRIORITY CLAIM

This application claims priority from Korean Patent Application No. 10-2018-0113020 filed on Sep. 20, 2018 in the Korean Intellectual Property Office, and all the benefits accruing therefrom under 35 U.S.C. § 119, the disclosure of which is incorporated herein by reference in its entirety.

### BACKGROUND

### Field of the Disclosure

The present disclosure relates to an industrial glove coated with a polyurea resin composition and a silicone resin, and a method of manufacturing the same. More particularly, the present disclosure relates to an industrial glove that is coated with a water-soluble polyurea resin composition and then coated with a liquid silicone resin so that the liquid silicone resin does not permeate into an inner skin of the glove, and a method of manufacturing the same.

### Description of the Related Art

Conventionally, there is a method of impregnating a target object with a resin having permeability as a method of forming a film including the resin on the target object. In this case, the resin only permeates into the target object so that a film is not formed. Thus, to prevent a resin composition from permeating into a target object, a method of performing water-repellent treatment on a surface of the target object and impregnating the treated target object with the resin composition has been used. In this regard, the water-repellent treatment of the surface of the target object is performed using an alcohol, potassium hydroxide, calcium chloride, calcium nitrate, or the like, and in the case of alcohols, there is a risk of fire, and other chemical products are harmful to the human body. In addition, after producing products, surfaces of which have been subjected to water-repellent treatment, the products are washed again to remove chemicals and dried, and in these processes, it is difficult to perform complete washing and a lot of costs are incurred.

Therefore, a resin capable of forming a coating film on a target object has been used, but in this case, the resin is not able to permeate into the target object and forms only a coating film, so that the target object and the resin are easily separated from each other.

### SUMMARY

Meanwhile, an industrial glove, on which a coating film is formed, may require a coating film having superior heat resistance and superior chemical resistance according to a working environment. For example, when a high-temperature working environment such as a glass plant is required, an industrial glove coated with a silicone resin and thus having excellent durability may be used. However, the silicone resin has higher viscosity than other polymer resins, and thus it is difficult to manufacture a glove with a coating film having a uniform thickness formed thereon. Thus, a method of forming a coating film using a silicone resin that has reduced viscosity by adding a catalyst thereto has been developed, and in this case, the silicone resin may permeate into an inner skin of a glove according to the viscosity of the silicone resin, and accordingly, mass production thereof is impossible and a user feels discomfort when wearing the glove.

Aspects of the present disclosure provide an industrial glove that is coated with a polyurea resin, followed by a surface thereof being coated with a silicone resin, and a method of manufacturing the same. Accordingly, an industrial glove that has excellent heat resistance and excellent chemical resistance and does not cause discomfort when worn may be provided.

It should be noted that objects of the present disclosure are not limited to the above-described objects, and other objects of the present disclosure will be apparent to those skilled in the art from the following descriptions.

According to an exemplary embodiment of the present disclosure, an industrial glove comprises: a glove; a first coating film disposed on the glove and comprising a polyurea resin; and a second coating film disposed on the first coating film and comprising a silicone resin, wherein the first coating film comprises: an inner film layer formed such that an inner skin of the glove is partially impregnated with at least a part of the polyurea resin, but the at least a part of the polyurea resin does not permeate into an inner surface of the glove; and a coating layer formed of the remainder of the polyurea resin on an outer surface of the glove.

In an exemplary embodiment, the polyurea resin has a viscosity ranging from about 100 cps to about 300 cps, and the silicone resin has a viscosity ranging from about 6,000 cps to about 15,000 cps.

In an exemplary embodiment, the second coating film is formed on the coating layer, and the silicone resin of the second coating film does not permeate into the inner skin of the glove due to the coating layer.

In an exemplary embodiment, the polyurea resin comprises: about 15 parts by weight to about 17.5 parts by weight of a polyol; about 0.5 part by weight to about 1.5 parts by weight of a dispersant; about 4.5 parts by weight to about 6.5 parts by weight of a first monomer; and about 1 part by weight to about 2 parts by weight of a second monomer.

In an exemplary embodiment, the dispersant comprises dimethylolpropionic acid (DMPA), the first monomer comprises methylene diphenyl diisocyanate (MDI) or isophorone diisocyanate (IPDI), and the second monomer comprises triethanolamine (TEA) or piperazine.

According to an exemplary embodiment of the present disclosure, a method of manufacturing an industrial glove comprises: preparing a polyurea resin composition and a silicone resin composition; forming a first coating film comprising a polyurea resin on a glove by dipping the glove in the polyurea resin composition; and forming a second coating film including a silicone resin on the first coating film by dipping the glove with the first coating film formed thereon in the silicone resin composition.

In an exemplary embodiment, the polyurea resin composition has a viscosity ranging from about 100 cps to about 300 cps, and the silicone resin composition has a viscosity ranging from about 6,000 cps to about 15,000 cps.

In an exemplary embodiment, the forming of the first coating film comprises: heating the polyurea resin composition to a temperature ranging from about 30° C. to about 50° C.; dipping the glove in the polyurea resin composition; and drying the glove dipped in the polyurea resin composition at a temperature ranging from about 70° C. to about 120° C. for about 60 minutes to about 120 minutes.

In an exemplary embodiment, the forming of the second coating film comprises: a defoaming process for removing air bubbles included in the silicone resin composition in a vacuum; a dipping process of dipping the glove with the first coating film formed thereon in the defoamed silicone resin composition; a first drying process of drying the glove dipped in the silicone resin composition after the glove has been disposed such that the glove faces a first direction to remove at least a part of the silicone resin composition; and a second drying process of drying the glove after the glove has been disposed such that the glove faces a second direction, the second direction being different from the first direction.

In an exemplary embodiment, the first drying process is performed for about 10 minutes to about 30 minutes.

In an exemplary embodiment, the second drying process is performed at a temperature ranging from about 80° C. to about 120° C. for about 10 minutes to about 60 minutes.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a schematic view illustrating an industrial glove coated with a polyurea resin and a silicone resin, according to an embodiment of the present disclosure;

FIG. 2 is an enlarged cross-sectional view of portion A of FIG. 1;

FIG. 3 is a flowchart illustrating a method of manufacturing an industrial glove, according to an embodiment of the present disclosure;

FIG. 4 is a flowchart illustrating a process of forming a second coating film including a silicone resin, according to an embodiment of the present disclosure;

FIG. 5 is a schematic view illustrating a first drying process according to an embodiment of the present disclosure;

FIG. 6 is a schematic view illustrating a second drying process according to an embodiment of the present disclosure;

FIGS. 7A and 7B illustrate images of an industrial glove coated with a polyurea resin and a silicone resin, according to a preparation example of the present disclosure;

FIGS. 8A, 8B, 8C, 8D, 8E and 8F illustrate images of gloves coated with a silicone resin, according to comparative examples of the present disclosure;

FIGS. 9A and 9B illustrate images of gloves coated with a silicone resin, according to other comparative examples of the present disclosure;

FIG. 10 is an image illustrating a glove coated with a silicone resin, on which a defoaming process has not been performed, according to a comparative example of the present disclosure; and

FIG. 11 is an image illustrating a glove manufactured without performing a first drying process, according to a comparative example of the present disclosure.

### DETAILED DESCRIPTION OF THE EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art.

It will also be understood that when a layer is referred to as being “on” another layer or substrate, it can be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

As used herein, the term “and/or” includes any and all combinations of one or more of the associated listed items. A numerical range expressed using “to” means a range including numerical values before and after “to” as a lower limit and an upper limit, respectively. The term “about” or “approximately” as used herein refers to a value or numerical range within 20% of the value or numerical range described after the term.

Hereinafter, embodiments of the present disclosure will be described with reference to the accompanying drawings.

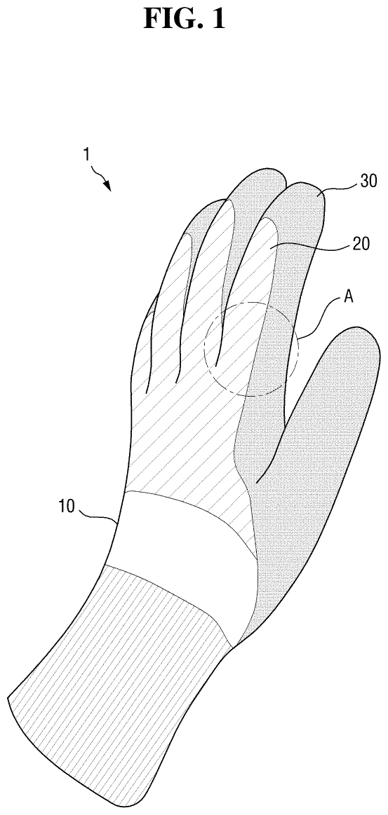

FIG. 1 is a schematic view illustrating an industrial glove 1 coated with a polyurea resin and a silicone resin, according to an embodiment of the present disclosure.

Referring to FIG. 1, the industrial glove 1 may include a glove 10, and first and second coating films 20 and 30 formed on the glove 10.

The glove 10 may be a glove commonly used in the industrial field. The first and second coating films 20 and 30 may be formed on an outer surface of the glove 10, thereby enhancing durability, heat resistance, chemical resistance, and the like of the industrial glove 1.

The industrial glove 1 according to an embodiment of the present disclosure includes the glove 10, the first coating film 20 disposed on the glove 10 and including a polyurea resin, and the second coating film 30 disposed on the first coating film 20 and including a silicone resin, and the first coating film 20 may include an inner film layer 22 formed such that an inner skin of the glove 10 is partially impregnated with at least a part of the polyurea resin, but the at least a part of the polyurea resin does not permeate into an inner surface of the glove 10, and a coating layer 21 formed of the remainder of the polyurea resin and formed on an outer surface of the glove 10.

The first coating film 20 may include a polyurea resin. The polyurea resin according to an embodiment of the present disclosure has water solubility, and thus may have both permeability, which enables the inner skin of the glove 10 to be partially impregnated therewith, and coating film formability, which enables the polyurea resin to form a coating layer on the outer surface of the glove 10.

According to one embodiment, the polyurea resin may include about 15 parts by weight to about 17.5 parts by weight of a polyol, about 0.5 part by weight to about 1.5 parts by weight of a dispersant, about 4.5 parts by weight to about 6.5 parts by weight of a first monomer, and about 1 part by weight to about 2 parts by weight of a second monomer.

In an exemplary embodiment, the polyol may be polypropylene glycol, the dispersant may be dimethylolpropionic acid (DMPA), the first monomer may be methylene diphenyl diisocyanate (MDI) or isophorone diisocyanate (IPDI), and the second monomer may be triethanolamine (TEA) or piperazine, but the present disclosure is not limited to the above examples.

The polyurea resin may have water solubility due to the inclusion of the added dispersant and the first monomer, which is hydrophilic. In addition, a chain length of the polyurea resin may be increased by the second monomer, and the polyurea resin may form a coating film on the outer surface of the glove 10.

That is, when forming the first coating film 20 on the glove 10, at least a part of the polyurea resin may permeate into the inner skin of the glove 10 to thereby form the inner film layer 22, and the remainder thereof may form the coating layer 21 on the outer surface of the glove 10. The inner film layer 22 of the first coating film 20 may be formed by adjusting water solubility according to the amounts of the dispersant and hydrophilic first monomer included in the polyurea resin. The coating layer 21 of the first coating film 20 may be formed by adjusting the chain length of the polyurea resin according to the amount of the second monomer included in the polyurea resin. Accordingly, the first coating film 20 may be formed such that the inner film layer 22 is formed without a part of the polyurea resin permeating into an inner surface of the glove 10, and the remainder thereof forms the coating layer 21 on the outer surface of the glove 10, thereby enhancing the durability of the industrial glove 1. In addition, as described below, since the coating layer 21 formed of the polyurea resin has water solubility, the second coating film 30 disposed thereon and including a silicone resin may be adhered thereto relatively firmly.

The polyurea resin having both permeability and coating film formability may be prepared by forming a prepolymer at a certain temperature, dispersing the prepolymer, and then performing polymerization by adding a monomer thereto. This will be described in more detail below.

Meanwhile, the second coating film 30 may include a silicone resin and may be formed on the first coating film 20.

Silicone resins may have relatively higher viscosity than polyurea resins, and may have excellent heat resistance and excellent chemical resistance. Accordingly, the industrial glove 1, which is used in a harsh working environment, may exhibit enhanced durability by including the second coating film 30 including a silicone resin.

However, in a case in which the viscosity of the silicone resin is too high, the silicone resin may include a low-viscosity silicone resin functioning as a catalyst that increases fluidity. In an exemplary embodiment, the silicone resin of the present disclosure may include about 1 part by weight to about 5 parts by weight of a low-viscosity silicone resin with respect to 100 parts by weight of a silicone resin composition. However, the present disclosure is not limited thereto.

Accordingly, according to one embodiment of the present disclosure, the polyurea resin may have a viscosity of about 100 cps to about 300 cps, and the silicone resin may have a viscosity of about 6,000 cps to about 15,000 cps.

The silicone resin may have relatively low viscosity due to the inclusion of a low-viscosity silicone resin, and may form, on the glove 10, the second coating film 30 that has a uniform and small thickness.

Meanwhile, according to one embodiment of the present disclosure, the second coating film 30 may be formed on the coating layer 21 of the first coating film 20, and the silicone resin of the second coating film 30 may not permeate into the inner skin of the glove 10 due to the coating layer 21.

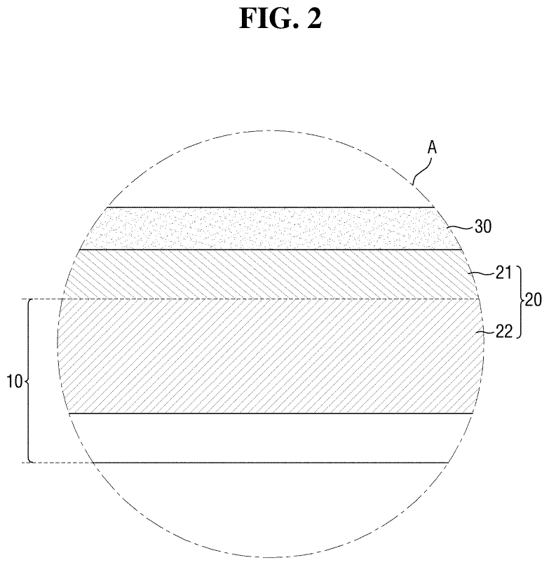

FIG. 2 is an enlarged cross-sectional view of portion A of FIG. 1.

Referring to FIG. 2, the industrial glove 1 may include the first coating film 20 including the inner film layer 22 formed such that the inner skin of the glove 10 is partially impregnated with at least a part of the polyurea resin and the coating layer 21 disposed on the outer surface of the glove 10; and the second coating film 30 disposed on the first coating film 20.

As described above, the first coating film 20 may include the inner film layer 22 formed such that the inner skin of the glove 10 is partially impregnated with at least a part of the polyurea resin, but the at least a part of the polyurea resin does not permeate into the inner surface of the glove 10, and the coating layer 21 formed of the remainder of the polyurea resin and formed on the outer surface of the glove 10.

As described below, a process of forming the first coating film 20 on the glove 10 may be performed by dipping the glove 10 in a container including a polyurea resin composition. In this regard, an inner fiber skin of the glove 10 is impregnated with a part of the polyurea resin composition to form the inner film layer 22, and the remainder of the polyurea resin composition may remain on the outer surface of the glove 10 to form the coating layer 21.

A polyurea resin composition according to one embodiment may be present in a form in which a water-soluble polyurea resin is dispersed in a solvent. When the glove 10 is dipped in the polyurea resin composition, the inner fiber skin of the glove 10 may be impregnated with the polyurea resin dispersed in the solvent. However, the polyurea resin composition has a density not allowing the composition to permeate into the inner surface of the glove 10. Accordingly, when a user wears the industrial glove 1, a sense of a foreign body in the inner surface of the glove 10 may be minimized, and adhesion between the first coating film 20 and the glove 10 may also be enhanced.

In addition, the second coating film 30 including a silicone resin may be formed on the first coating film 20.

In particular, the second coating film 30 may be formed on the coating layer 21 of the first coating film 20 such that the silicone resin does not permeate into the inner skin of the glove 10. Since the polyurea resin has water solubility, the coating layer 21 may have strong adhesion to the second coating film 30 disposed thereon and including a silicone resin.

In addition, the first coating film 20 including a polyurea resin may have waterproofness, thus not enabling a liquid such as water to permeate thereinto from the outside. Since the first coating film 20 is formed such that only a part of the polyurea resin permeates into the inner skin of the glove 10, although the glove 10 is dipped in a silicone resin, the silicon resin may form the second coating film 30 without permeating into the inner skin of the glove 10.

In a case in which the glove 10 is directly coated with a silicone resin, a high-viscosity silicone resin may be unable to permeate into the inner skin of the glove 10, thereby reducing adhesion. Although a silicone resin having reduced viscosity due to the inclusion of a low-viscosity silicone resin may permeate into the inner skin of the glove 10 and thus have adhesion, when the glove 10 is impregnated with an excess amount of the silicone resin, the silicone resin may permeate into the inner surface of the glove 10 or may form a thick coating film on the outer surface of the glove 10.

In contrast, the industrial glove 1 according to an embodiment of the present disclosure may be configured such that the second coating film 30 having a small thickness is formed by adjusting the viscosity of the silicone resin, and the first coating film 20 including a polyurea resin is formed so that the silicone resin does not permeate into the inner skin of the glove 10.

In other words, the first coating film 20 including a polyurea resin may not only prevent a silicone resin included in the second coating film 30 from permeating into the inner skin of the glove 10, but may also adhere the silicone resin to the glove 10. Accordingly, when a user wears the industrial glove 1 including the second coating film 30 including a silicone resin, the industrial glove 1 may exhibit enhanced wearability since the silicone resin does not permeate into the inner surface of the glove 10, and may exhibit enhanced heat resistance and chemical resistance due to the second coating film 30 formed of a silicone resin on the outer surface thereof. A detailed description thereof will be provided below with reference to experimental examples.

Meanwhile, the industrial glove 1 may be manufactured by forming the first coating film 20 including a polyurea resin on the glove 10, and forming, on the first coating film 20, the second coating film 30 including a silicone resin. Hereinafter, a method of manufacturing the industrial glove 1, according to another embodiment of the present disclosure, will be described.

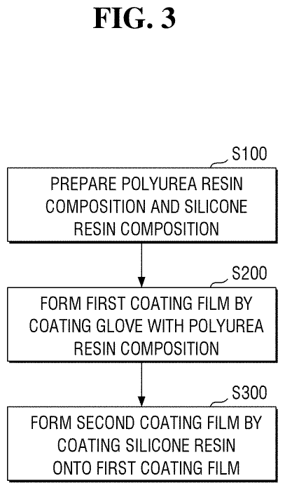

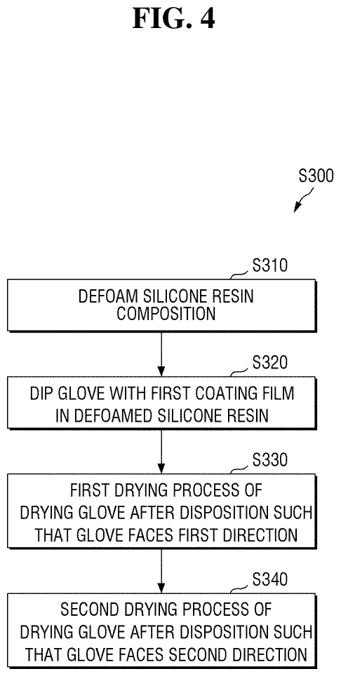

FIG. 3 is a flowchart illustrating a method of manufacturing the industrial glove 1, according to an embodiment of the present disclosure.

Referring to FIG. 3, the method of manufacturing the industrial glove 1, according to an embodiment of the present disclosure, may include: preparing a polyurea resin composition and a silicone resin composition (operation S100); forming the first coating film 20 including a polyurea resin on the glove 10 by dipping the glove 10 in the polyurea resin composition (operation S200); and forming the second coating film 30 including a silicone resin on the first coating film 20 by dipping the glove 10 with the first coating film 20 formed thereon in the silicone resin composition (operation S300).

First, a polyurea resin composition and a silicone resin composition are prepared (operation S100). The polyurea resin composition and the silicone resin composition may have the same compositions and physical properties as those described above.

In an exemplary embodiment, the polyurea resin composition may have a viscosity of about 100 cps to about 300 cps, and the silicone resin composition may have a viscosity of about 6,000 cps to about 15,000 cps. The silicone resin composition may include a low-viscosity silicone resin, and the polyurea resin composition may include about 15 parts by weight to about 17.5 parts by weight of a polyol, about 0.5 part by weight to about 1.5 parts by weight of a dispersant, about 4.5 parts by weight to about 6.5 parts by weight of a first monomer, and about 1 part by weight to about 2 parts by weight of a second monomer.

In one embodiment, a method of preparing the polyurea resin composition may include: forming a prepolymer by mixing about 50 parts by weight to about 80 parts by weight of a polyol, about 4 parts by weight to about 8 parts by weight of a dispersant, and about 20 parts by weight to about 30 parts by weight of a first monomer containing an isocyanate group; forming a first composition by mixing the prepolymer with about 2 parts by weight to about 4 parts by weight of a second monomer containing an amine group; stirring and emulsifying the first composition with about 100 parts by weight to about 200 parts by weight of a solvent; and forming a second composition by further adding about 0.2 part by weight to about 1.5 parts by weight of the second monomer to the emulsified first composition and stirring the resulting composition.

First, in formation of the prepolymer, the polyol may form a basic skeleton of the polyurea resin composition. A polyol contains hydroxyl groups in a molecule, and thus reacts with isocyanate groups, which will be described below, thereby forming a prepolymer.

The dispersant may be added to the polyol so as to impart water solubility to the polyurea resin composition, thereby forming a prepolymer. In an exemplary embodiment, the dispersant may be dimethylolpropionic acid (DMPA). The polyurea resin composition further includes a dispersant, and thus may have water solubility, and the dispersant may allow polyurea resin particles to be dispersed in the composition.

The first monomer may contain an isocyanate group. The isocyanate group may form a monomer in the polyurea resin composition by reacting with the polyol. In an exemplary embodiment, the first monomer containing an isocyanate group may be methylene diphenyl diisocyanate (MDI) or isophorone diisocyanate (IPDI), but the present disclosure is not limited thereto.

In addition, the first monomer containing an isocyanate group may be hydrophilic, and thus the formed prepolymer may have hydrophilicity due to the dispersant and the first monomer. As described above, the first monomer containing an isocyanate group may impart water solubility to the polyurea resin composition, thereby enhancing permeability.

The prepolymer formed by mixing the polyol, the dispersant, and the first monomer containing an isocyanate group may be mixed with the second monomer containing an amine group to thereby form a polyurea resin composition, in a subsequent process. In some embodiments, the prepolymer may be formed by mixing about 50 parts by weight to about 80 parts by weight of a polyol, about 4 parts by weight to about 8 parts by weight of a dispersant, and about 20 parts by weight to about 30 parts by weight of a second monomer, and in other embodiments, the prepolymer may be formed by mixing 70 parts by weight of a polyol, 4 parts by weight of a dispersant, and 23 parts by weight of a first monomer. However, the present disclosure is not limited to the above examples.

Meanwhile, in an exemplary embodiment, the formation of the prepolymer may include: a first mixing process of dissolving the polyol and the dispersant at a temperature ranging from about 80° C. to about 95° C.; mixing the dissolved polyol and dispersant with the first monomer and heating the resulting mixture to a temperature ranging from about 100° C. to about 120° C.; and a second mixing process of further adding the first monomer to the heated mixture and allowing the resulting mixture to react at a temperature ranging from about 80° C. to about 100° C.

The first monomers may be different compounds containing an isocyanate group, and these first monomers may be each independently mixed in different processes, thereby forming a prepolymer. For example, in the first mixing process, the first monomer included in the dissolved polyol and dispersant may be diphenyl diisocyanate, and the first monomer further added in the second mixing process may be isophorone diisocyanate. However, the present disclosure is not limited to the above examples.

The polyurea resin composition prepared by the above-described processes may have water solubility due to the prepolymer including the added dispersant and the first monomer, which is hydrophilic.

Next, the prepolymer is mixed with about 2 parts by weight to about 4 parts by weight of a second monomer containing an amine group to form a first composition.

The second monomer containing an amine group may form a first composition by reacting with the prepolymer. The first composition may be understood as a composition formed by polymerization of some monomers before forming a final polyurea resin composition. In other words, the first composition may include a composition polymerized by a partial reaction between the prepolymer and the second monomer.

The second monomer may contain an amine group, thereby leading to polymerization with the isocyanate group of the prepolymer. The isocyanate group of the first monomer included in the prepolymer may react with the amine group of the second monomer, thereby forming a urea group.

In an exemplary embodiment, the second monomer containing an amine group may be piperazine or triethanolamine (TEA), but the present disclosure is not limited thereto.

In addition, the second monomer may neutralize the acidity of the dispersant included in the prepolymer, for example, dimethylolpropionic acid, in the above-described process. The second monomer includes an amine group having basicity, and thus may neutralize the acidity of the dispersant, thereby controlling the pH of the prepared polyurea resin composition.

In an exemplary embodiment, in formation of the first composition, the second monomer containing an amine group may be mixed in an amount of about 2 parts by weight to about 4 parts by weight, about 2.5 parts by weight to about 3.5 parts by weight, or 3 parts by weight. In addition, the formation of the first composition may be performed at a temperature ranging from about 60° C. to about 80° C. However, the present disclosure is not limited thereto. In a subsequent process, the first composition may be further mixed with a different type of second monomer, thereby forming a second composition.

Next, the first composition is stirred and emulsified with about 100 parts by weight to about 200 parts by weight of a solvent.

As the first composition and the solvent are stirred and emulsified, the first composition may be uniformly dispersed in the solvent. Accordingly, the prepared polyurea resin composition forms relatively small particles and has water solubility, and thus, when an industrial glove is coated therewith, the polyurea resin composition may partially permeate into an inner skin of the industrial glove. In a case in which the first composition and the solvent are stirred, when the amount of the solvent is insufficient, the first composition may not be uniformly dispersed. In this case, when an industrial glove is coated with such a polyurea resin composition, the polyurea resin composition may exhibit poor permeability, and thus adhesion of the formed coating layer to the glove may deteriorate.

In an exemplary embodiment, the solvent may be water (H₂O), and the first composition and the solvent may be stirred at about 1,200 rpm to about 1,900 rpm for about 30 minutes to about 60 minutes. However, the present disclosure is not limited thereto.

Lastly, about 0.2 part by weight to about 1.5 parts by weight of the second monomer may be further added to the emulsified first composition and stirred therein to form a second composition.

In the present process, the second composition may be formed by mixing the emulsified first composition with the second monomer, thereby preparing a polyurea resin composition. The second composition may be formed by a reaction between the first composition and the second monomer, and the polyurea resin composition prepared thereby may have coating film formability.

A chain length of a polyurea resin included in the prepared polyurea resin composition may be adjusted according to an amount of the second monomer added to the second composition. In a case in which the second monomer is added in an amount greater than the above-described range, when an industrial glove is coated with the prepared polyurea resin composition, the polyurea resin composition is not able to permeate into the fiber tissue of the industrial glove, and thus the formed coating may peel off of the glove due to poor adhesion thereof to the glove.

In contrast, in a case in which the second monomer is added in an amount less than the above-described range, when an industrial glove is coated with the prepared polyurea resin composition, an excess amount of the polyurea resin composition may permeate into fiber tissue of the glove so that the composition may permeate into an inner surface of the glove. In other words, the percentage of permeability and coating film formability of the prepared polyurea resin composition may be determined according to the amount of the second monomer. Thus, the second monomer needs to be added in an amount within the above-described range.

Meanwhile, in an exemplary embodiment, the second monomer mixed in the formation of the first composition may be triethanolamine (TEA), and the second monomer added in formation of the second composition may be piperazine. As described above, when the second composition is formed, the chain length of the polyurea resin may be adjusted according to the amount of the second monomer, and if needed, a molecular weight of the polyurea resin may be increased. In this case, the second composition may be formed by adding a second monomer that is different from the second monomer mixed in the formation of the first composition. However, the present disclosure is not limited to the above example.

In addition, in some embodiments, the formation of the second composition may include mixing the emulsified first composition and the second monomer at a temperature ranging from about 20° C. to about 50° C., adding about 100 parts by weight to about 300 parts by weight of a solvent to the mixed first composition, and stirring the resulting composition at about 1,000 rpm to about 1,500 rpm.

The solvent may be water (H₂O), and the second composition may be in a form dispersed in a solvent. When stirring is performed using a sufficient amount of the solvent, the finally prepared polyurea resin composition may form a soft and robust coating film.

Next, the first coating film 20 including a polyurea resin is formed on the glove 10 by dipping the glove 10 in the prepared polyurea resin composition (operation S200).

According to one embodiment of the present disclosure, the formation of the first coating film 20 (operation S200) may include heating the polyurea resin composition to a temperature ranging from about 30° C. to about 50° C., dipping the glove 10 in the polyurea resin composition, and drying the glove 10 dipped in the polyurea resin composition at a temperature ranging from about 70° C. to about 120° C. for about 60 minutes to 120 minutes.

Unlike a silicone resin, since the polyurea resin composition has a relatively low viscosity, e.g., about 100 cps to about 300 cps, when the glove 10 is dipped therein, a coating film with fluidity and a small thickness may be formed. In addition, as described above, the polyurea resin composition may include water (H₂O) as a solvent, and thus may be easily dried at a temperature ranging from about 70° C. to about 120° C. Accordingly, the glove 10 with the first coating film 20 including a polyurea resin formed thereon may be manufactured.

Next, the second coating film 30 including a silicone resin is formed on the first coating film 20 by dipping the glove 10 with the first coating film 20 formed thereon in the silicone resin composition (operation S300).

In particular, according to one embodiment of the present disclosure, the formation of the second coating film 30 (operation S300) may include a defoaming process for removing air bubbles included in the silicone resin composition in a vacuum (operation S310), a dipping process of dipping the glove 10 with the first coating film 20 formed thereon in the silicone resin composition from which air bubbles have been removed (operation S320), a first drying process of drying the glove 10 dipped in the silicone resin composition after arranging the glove 10 such that the glove 10 faces a first direction D1, to remove at least a part of the silicone resin composition (operation S330), and a second drying process of drying the glove 10 after arranging the glove 10 such that the glove 10 faces a second direction D2 that is different from the first direction D1 (operation S340).

First, a defoaming process for removing air bubbles included in the silicone resin composition in a vacuum is performed (operation S310). In the subsequent process, air bubbles may be generated in the silicone resin composition when the glove 10 is dipped therein or the silicone resin composition is mixed with a curing agent. If these air bubbles are not removed, air bubbles may be formed on the outer surface of the finally manufactured industrial glove 1, which may deteriorate the elongation and durability of the industrial glove 1.

Thus, before dipping the glove 10 in the silicone resin composition, the defoaming process for removing air bubbles formed in the silicone resin composition (operation S310) needs to be performed. In an exemplary embodiment, the defoaming process (operation S310) may be performed for about 10 minutes to about 120 minutes, or about 30 minutes to about 120 minutes. However, the present disclosure is not limited thereto.

Next, the glove 10 with the first coating film 20 formed thereon is dipped in the silicone resin composition from which air bubbles have been removed (operation S320).

As described above, the silicone resin composition may include a low-viscosity silicone resin and thus have a viscosity of about 6,000 cps to about 15,000 cps. Since the silicone resin composition has a higher viscosity than the polyurea resin composition, when dipping the glove 10 in the silicone resin composition, the glove 10 may be dipped in an excess amount of a silicone resin, which is greater than required to form the second coating film 30.

For example, in the dipping process of dipping the glove 10 with the first coating film 20 formed thereon in the silicone resin composition (operation S320), the glove 10 may be dipped in the silicone resin composition having an amount five times to ten times that required to form the second coating film 30. When curing the silicone resin composition by directly drying the glove 10 in this state, the second coating film 30 formed on the glove 10 may be non-uniform and thicker than required. Thus, the manufactured industrial glove 1 may be not suitable for use as a working glove.

Thus, to prevent this, the formation of the second coating film 30 (operation S300) may include the first drying process (operation S330) and the second drying process (operation S340).

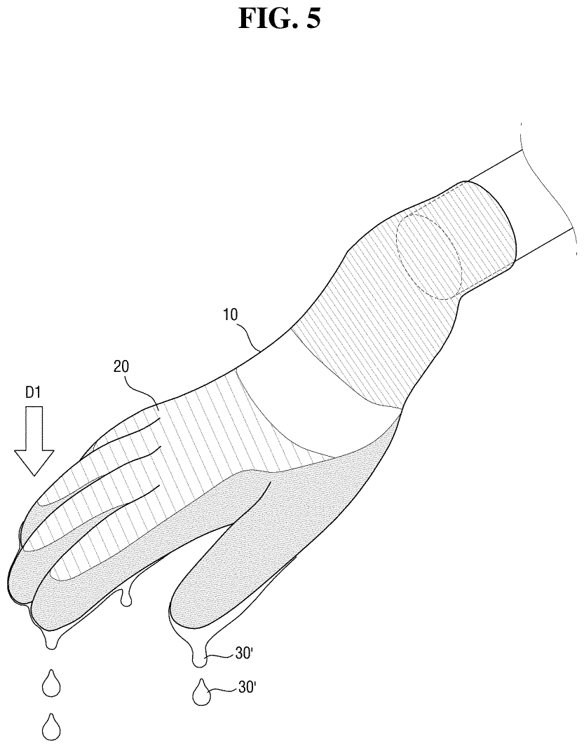

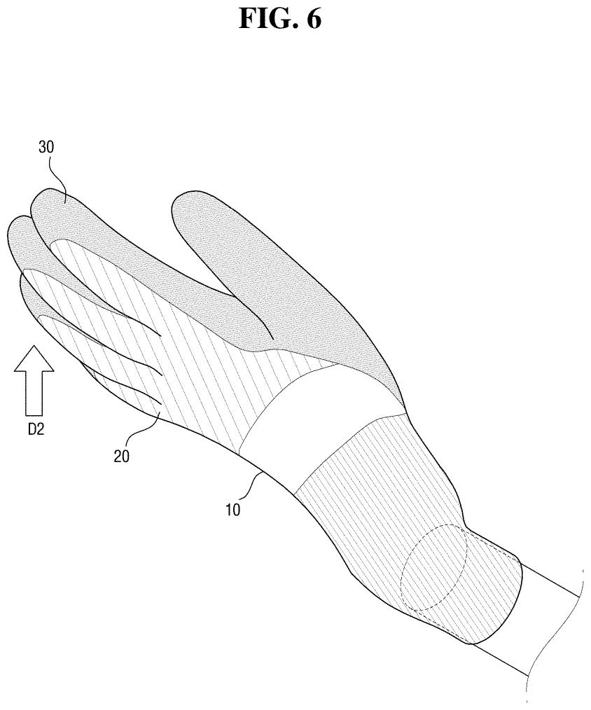

FIG. 5 is a schematic view illustrating a first drying process according to an embodiment of the present disclosure. FIG. 6 is a schematic view illustrating a second drying process according to an embodiment of the present disclosure.

Referring to FIG. 5, in the first drying process (operation S330), the glove 10 dipped in the silicone resin composition may be arranged such that the glove 10 faces a first direction D1, e.g., fingers of the glove 10 face the ground, and may be dried, thereby removing at least a part of the silicone resin composition.

The glove 10 dipped in an excess amount of a silicone resin composition 30′ may be placed such that fingers of the glove 10 face the ground, thereby removing a part of the excess amount of the silicone resin composition 30′.

According to one embodiment of the present disclosure, the first drying process (operation S330) may be performed for about 10 minutes to about 30 minutes.

When the excess amount of the silicone resin composition 30′ is removed in the first drying process (operation S330), drying time may be controlled such that the silicone resin does not form on fingertips of the glove 10. When the first drying process (operation S330) is excessively long, more than a required amount of the silicone resin composition 30′ may be removed, thus decreasing the thickness of the second coating film 30, and the silicone resin may be removed from a partial region of the glove 10 so that the second coating film 30 is not formed. On the other hand, when the first drying process (operation S330) is too short, only a small amount of the silicone resin composition 30′ is removed, and thus the thickness of the second coating film 30 may not be uniform. Thus, to appropriately remove the excess amount of the silicone resin composition 30′, the first drying process (operation S330) may be performed for a period of time within the above-described range.

In this regard, the first direction D1 which the glove 10 faces may be the same direction as a direction in which gravity acts so that the excess amount of the silicone resin composition 30′ can be removed. In one embodiment, as described above, the excess amount of the silicone resin composition 30′ may be partially removed by placing the glove 10 such that fingers of the glove 10 face the ground. However, the present disclosure is not limited thereto, and the direction in which the glove 10 is disposed is not particularly limited as long as it is a direction enabling the excess amount of the silicone resin composition 30′ to be removed.

Lastly, referring to FIG. 6, in the second drying process (operation S340), the glove 10 may be disposed such that the glove 10 faces a second direction D2 different from the first direction D1, e.g., fingers of the glove 10 face a direction opposite to the ground, and may be dried.

The silicone resin composition 30′, a part of which has been removed in the first drying process (operation S330), may be present in an amount sufficient to have a uniform thickness on the glove 10. In the second drying process (operation S340), so as not to further remove the silicone resin composition 30′ on the glove 10, the glove 10 may be disposed such that the glove 10 faces the second direction D2 different from the first direction D1 and dried.

According to one embodiment of the present disclosure, the second drying process (operation S340) may be performed at a temperature ranging from about 80° C. to about 120° C. for about 10 minutes to about 60 minutes. However, the present disclosure is not limited thereto. Conditions under which the second drying process (operation S340) is performed are not particularly limited as long as the temperature and time allow the silicone resin composition to be cured.

According to the above-described processes, the industrial glove 1 including the first coating film 20 including a polyurea resin and the second coating film 30 including a silicone resin may be manufactured. The industrial glove 1 includes the first coating film 20 including the inner film layer 22 partially formed on the inner skin of the glove 10 and the coating layer 21 on the outer surface of the glove 10, and thus the second coating film 30 having a uniform thickness may be formed such that a silicone resin having a relatively low viscosity does not permeate into the inner skin of the glove 10 and the second coating film 30 is satisfactorily adhered to the first coating film 20.

Hereinafter, examples and experimental examples will be described to aid in understanding of the present disclosure. However, these examples are provided only for illustrative purposes and are not intended to limit the scope of the present disclosure.

### EXAMPLES

### Preparation Example 1. Industrial Glove Coated with Polyurea Resin and Silicone Resin

<Preparation of Polyurea Resin Composition and Silicone Resin Composition>

First, a polyurea resin composition and a silicone resin composition, which are resin compositions for forming coating films in an industrial glove, are prepared. The polyurea resin composition may include 75 parts by weight of water, 16.5 parts by weight of polypropylene glycol, a total of 5.9 parts by weight of methylene diphenyl diisocyanate (MDI) and isophorone diisocyanate (IPDI), a total of 1.4 parts by weight of triethanolamine (TEA) and piperazine, and 1.1 parts by weight of dimethylolpropionic acid (DMPA). The viscosity of the prepared polyurea resin composition may range from about 100 cps to about 300 cps.

In particular, the polyurea resin composition may include 70 kg of polypropylene glycol as a polyol, 5 kg of DMPA as a dispersant, 13 kg of MDI and 10 kg of IPDI as first monomers, and 3 kg of triethanolamine and 1 kg of piperazine as second monomers, and may be prepared in a form dispersed in a solvent.

The silicone resin composition, which is in a liquid state, may have a viscosity of about 8,000 cps to about 40,000 cps. To adjust viscosity, the silicone resin composition used in the present preparation example is prepared by stirring a low-viscosity silicone resin in an amount of about 1 part by weight to about 5 parts by weight with respect to 100 parts by weight of the silicone resin composition. Accordingly, the prepared silicone resin composition may have a viscosity ranging from about 6,000 cps to about 15,000 cps. By mixing the low-viscosity silicone resin in the silicone resin composition, the silicone resin composition may have enhanced fluidity and a coating film formed of the silicone resin may have a uniform thickness.

<Formation of First Coating Film>

Next, a first coating film is formed using the polyurea resin composition. To form a coating film of an industrial glove, a cotton fabric glove is prepared.

First, the prepared polyurea resin composition is heated to a temperature ranging from about 30° C. to about 50° C., and then supplied to a water tank of a first dipping machine. Then, the cotton fabric glove is fitted onto a mold, and then the cotton fabric glove is dipped in the polyurea resin composition contained in the water tank of the first dipping machine for about 1 second to about 3 seconds. The dipped glove is dried in a state in which it is fitted onto the mold at a temperature of about 70° C. to about 120° C. for about 60 minutes to about 120 minutes. At this time, the solvent included in the polyurea resin composition is removed, and a first coating film including a polyurea resin is formed on the cotton fabric glove.

As described above, the first coating film may include an inner film layer formed such that at least a part of the polyurea resin partially permeates into an inner skin of the cotton fabric glove, and a coating layer formed, on an outer skin of the cotton fabric glove, of the remainder of the polyurea resin. The prepared polyurea resin composition may have water solubility, and thus, a part thereof may permeate into the inner skin of the cotton fabric glove, but does not permeate into an inner surface of the cotton fabric glove, and the polyurea resin may form a coating layer with excellent durability on an outer surface of the glove.

<Formation of Second Coating Film>

A second coating film including a silicone resin is formed on the cotton fabric glove with the first coating film formed thereon. To form the second coating film, the cotton fabric glove with the first coating film formed thereon is fitted onto a mold of a second dipping machine.

(1) First, to remove air bubbles included in the prepared silicone resin composition, a defoaming process is performed in a vacuum state. The silicone resin composition is supplied to a vacuum defoamer, and the defoaming process is performed for about 30 minutes to about 120 minutes.

(2) Next, the silicone resin composition on which the defoaming process has been performed is supplied to a water tank of the second dipping machine, and the cotton fabric glove with the first coating film formed thereon is dipped in the prepared silicone resin composition. The silicone resin composition has a higher viscosity than the polyurea resin composition, and thus the glove is dipped therein for a longer period of time. In the present preparation example, the cotton fabric glove with the first coating film formed thereon is dipped for about 3 seconds to about 10 seconds.

(3) The cotton fabric glove dipped in the silicone resin composition is disposed in a first direction and dried to partially remove an excess amount of the silicone resin composition. Fingers of the cotton fabric glove are disposed such that they face a downward direction and dried for about 10 minutes to about 30 minutes such that the excess amount of the silicone resin composition flows downward.

(4) Lastly, the fingers of the cotton fabric glove from which the silicone resin composition has been removed partially are disposed such that they face a upward direction, and dried at a temperature of about 80° C. to about 120° C. for about 10 minutes to about 60 minutes, thereby forming a second coating film.

The industrial glove manufactured according to the above-described method includes the first coating film including a polyurea resin and the second coating film disposed on the first coating film and including a silicone resin. Hereinafter, the manufactured industrial glove is referred to as “Preparation Example 1”.

### Comparative Example 1: Industrial Glove Coated with Silicone Resin (1)

As a comparative example for Preparation Example 1, an industrial glove, in which a glove is directly coated with a silicone resin, is manufactured.

A silicone resin composition, which does not include the low-viscosity silicone resin included in the silicone resin composition prepared in Preparation Example 1, but includes a high-viscosity silicone resin, is prepared, and a cotton fabric glove is coated therewith, thereby completing the manufacture of an industrial glove.

In the process of coating with the silicone resin composition, a water-repelling agent for fibers, which includes a silicone resin, is diluted in water for preparation. Thereafter, the glove may be dipped in the diluted water-repelling solution, followed by dehydration and curing, and then dipped in the prepared silicone resin composition, thereby coating the glove therewith. At this time, the used water-repelling agent may be a water-soluble fluorine (F)-based water-repelling agent.

Hereinafter, the industrial glove manufactured according to the above processes is referred to as “Comparative Example 1”.

### Comparative Example 2: Industrial Glove Coated with Silicone Resin (2)

An industrial glove is manufactured in the same manner as Comparative Example 1, except that a silicone resin composition including a low-viscosity silicone resin in an amount of 1 part by weight with respect to 100 parts by weight of the silicone resin composition is prepared. Hereinafter, the industrial glove manufactured according to the above processes is referred to as “Comparative Example 2”.

### Comparative Example 3: Industrial Glove Coated with Silicone Resin (3)

An industrial glove is manufactured in the same manner as in Comparative Example 1, except that a silicone resin composition including a low-viscosity silicone resin in an amount of about 1 part by weight to about 5 parts by weight with respect to 100 parts by weight of the silicone resin composition is prepared. Hereinafter, the industrial glove manufactured according to the above processes is referred to as “Comparative Example 3”.

### Comparative Example 4: Industrial Glove Coated with Silicone Resin (4)

As a comparative example for Preparation Example 1, an industrial glove, in which a cotton fabric glove is directly coated with a silicone resin, is manufactured.

An industrial glove was manufactured in the same manner as in Preparation Example 1, except that a first coating film including polyurethane instead of the polyurea resin is formed. That is, in the present comparative example, the first coating film including polyurethane is formed on a cotton fabric glove, and a second coating film including a silicone resin is formed on the first coating film, thereby completing the manufacture of the industrial glove. Hereinafter, the industrial glove manufactured according to the above processes is referred to as “Comparative Example 4”.

### Comparative Example 5: Industrial Glove Coated with Silicone Resin (5)

An industrial glove is manufactured in the same manner as in Preparation Example 1, except that a first coating film including rubber such as nitrile-butadiene rubber (NBR) instead of the polyurea resin is formed. That is, in the present comparative example, a cotton fabric glove is coated with rubber such as NBR to form the first coating film, and a second coating film including a silicone resin is formed on the first coating film, thereby completing the manufacture of the industrial glove. Hereinafter, the industrial glove manufactured according to the above processes is referred to as “Comparative Example 5”.

### Comparative Example 6: Industrial Glove Manufactured without Defoaming Process

An industrial glove is manufactured in the same manner as in Preparation Example 1, except that a defoaming process is not performed on the prepared silicone resin composition. That is, in the present comparative example, a second coating film is formed in a state in which air bubbles are included in the silicone resin composition. Hereinafter, the industrial glove manufactured according to the above processes is referred to as “Comparative Example 6”.

### Comparative Example 7: Industrial Glove Manufactured without First Drying Process

An industrial glove is manufactured in the same manner as in Preparation Example 1, except that when forming a second coating film, the first drying process is not performed. That is, in the present comparative example, when forming the second coating film, fingers of a cotton fabric glove are disposed such that they face an upward direction and the silicone resin composition is dried only once, thereby completing the manufacture of the industrial glove. Hereinafter, the industrial glove manufactured according to the above processes is referred to as “Comparative Example 7”.

[Table 1] summarizes components and preparation conditions of the polyurea resin compositions of Preparation Example 1 and Comparative Examples 1 to 7.

TABLE 1

| | | Second coating film | Defoaming | First drying |
|---|---|---|---|---|
| | First coating film | (Silicone resin) | process | process |
| Preparation | Polyurea resin | 1 wt % to 5 wt % of | ◯ | ◯ |
| Example 1 | | low-viscosity silicone resin | | |
| Comparative | — | High-viscosity silicone | ◯ | ◯ |
| Example 1 | | resin | | |
| Comparative | — | 1 wt % or less of | ◯ | ◯ |
| Example 2 | | low-viscosity silicone | | |
| | | resin | | |
| Comparative | — | 1 wt % to 5 wt % of | ◯ | ◯ |
| Example 3 | | low-viscosity silicone | | |
| | | resin | | |
| Comparative | Polyurethane | 1 wt % to 5 wt % of | ◯ | ◯ |
| Example 4 | | low-viscosity silicone | | |
| | | resin | | |
| Comparative | NBR rubber | 1 wt % to 5 wt % of | ◯ | ◯ |
| Example 5 | | low-viscosity silicone | | |
| | | resin | | |
| Comparative | Polyurea resin | 1 wt % to 5 wt % of | X | ◯ |
| Example 6 | | low-viscosity silicone | | |
| | | resin | | |
| Comparative | Polyurea resin | 1 wt % to 5 wt % of | ◯ | X |
| Example 7 | | low-viscosity silicone | | |
| | | resin | | |

### Experimental Example: Evaluation of Coating Film Formability of Manufactured Industrial Gloves

Coating film formability of each of the industrial gloves of Preparation Example 1 and Comparative Examples 1 to 7 is evaluated, and results thereof are illustrated.

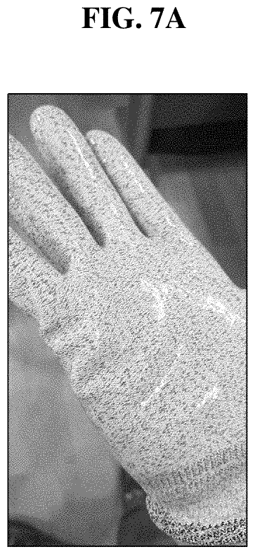

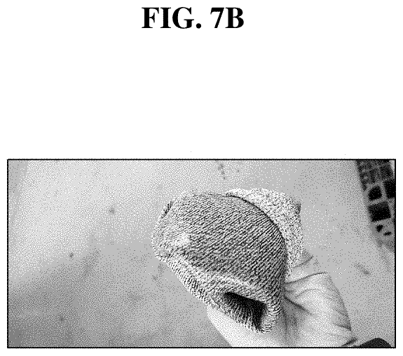

FIG. 7 illustrates images of an industrial glove coated with a polyurea resin and a silicone resin, according to a preparation example of the present disclosure.

FIG. 7A illustrates a coating film formed of a silicone resin and formed on an outer surface of the industrial glove according to Preparation Example 1. FIG. 7B illustrates an inner surface of the glove of Preparation Example 1.

Referring to FIG. 7A, it can be seen that the second coating film including a silicone resin is satisfactorily formed with a small and uniform thickness on the glove. In addition, referring to FIG. 7B, it can be seen that the silicone resin does not permeate into an inner skin of the glove.

As described above, this means that the second coating film having a uniform thickness is formed on the first coating film such that the silicone resin does not permeate into the inner skin of the glove due to the first coating film including a polyurea resin formed on the glove.

In the case of the industrial glove coated with a silicone resin of Preparation Example 1, to coat the glove with the silicone resin, a process of dehydrating the glove or performing water-repellent treatment thereon may be omitted. In addition, when coating the glove with the silicone resin, water is not used at all, and thus contaminated wastewater is not generated at all.

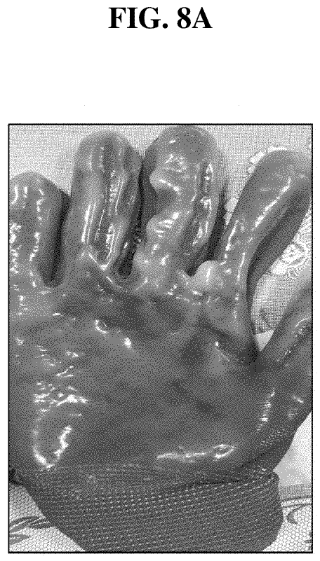

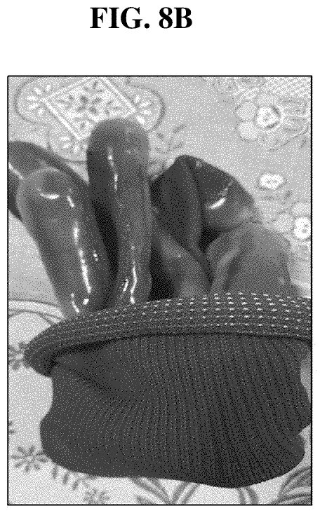

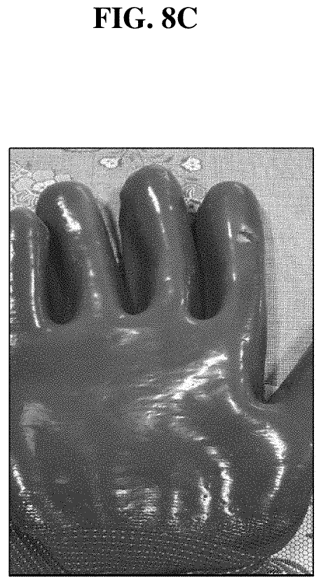

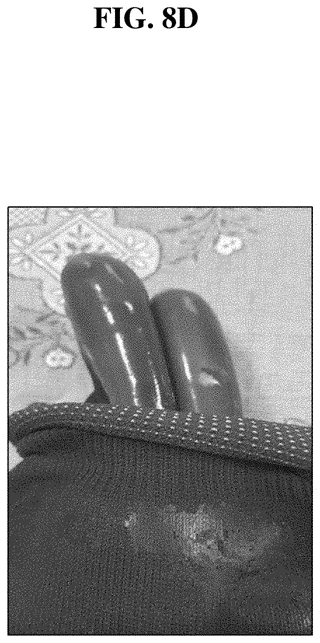

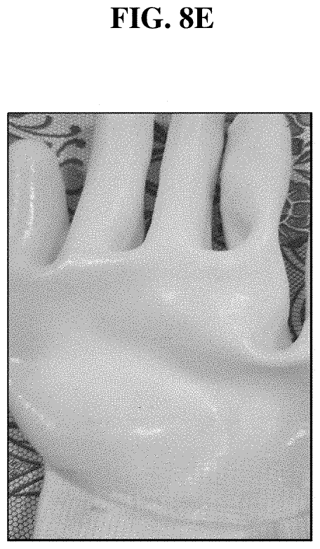

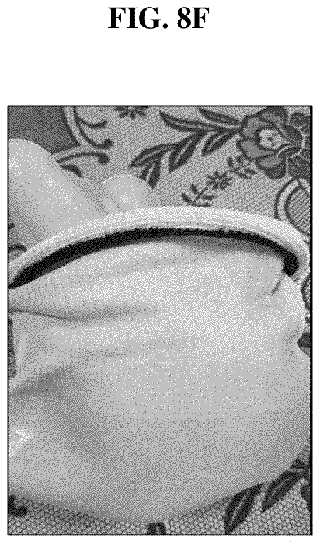

Next, FIG. 8 illustrates images of gloves coated with silicone resins according to comparative examples of the present disclosure.

FIG. 8A illustrates an outer surface of the industrial glove according to Comparative Example 1. FIG. 8B illustrates an inner surface of the industrial glove according to Comparative Example 1. FIG. 8C illustrates an outer surface of the industrial glove according to Comparative Example 2. FIG. 8D illustrates an inner surface of the industrial glove according to Comparative Example 2. FIG. 8E illustrates an outer surface of the industrial glove according to Comparative Example 3. FIG. 8F illustrates an inner surface of the industrial glove according to Comparative Example 3.

In the industrial glove with the second coating film including a silicone resin formed thereon, the second coating film having a uniform thickness has to be formed on an outer surface thereof, and the silicone resin should not permeate into an inner surface of the glove. Accordingly, the industrial glove may have heat resistance and chemical resistance due to the second coating film having a uniform thickness, and the silicone resin may not permeate into the inner surface of the glove, thus resulting in comfortable wearability when wearing the glove. In addition, when manufacturing an industrial glove, the glove may be easily separated from a mold due to a silicone resin in a glove separation process.

Referring to FIGS. 8A and 8B, it can be seen that in the case of the industrial glove according to Comparative Example 1, a silicone resin does not permeate into an inner surface of the glove, but the glove is directly coated with a silicone resin having high viscosity, and thus a coating film formed of the silicone resin and formed on the outer surface of the glove is unable to have a uniform thickness. In this case, when wearing the industrial glove of Comparative Example 1, comfortable wearability may be obtained, but the industrial glove may not be suitable for use as a working glove.

In contrast, referring to FIGS. 8C to 8F, it can be seen that coating films formed on outer surfaces of the gloves have a relatively uniform thickness in the industrial gloves of Comparative Examples 2 and 3, compared to the industrial glove of Comparative Example 1. However, as illustrated in FIG. 8C, the industrial glove of Comparative Example 2 includes a thick second coating film including a silicone resin, and thus is not suitable for use as a working glove. In addition, as illustrated in FIGS. 8D and 8F, the industrial gloves of Comparative Examples 2 and 3 include a low-viscosity silicone resin, and thus the silicone resin permeates into the inner surface of the glove. In this regard, when a user wears the industrial glove, a sense of a foreign body is caused, and it is difficult to separate the glove from a mold in a manufacturing process.

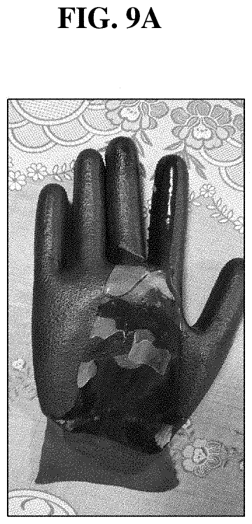

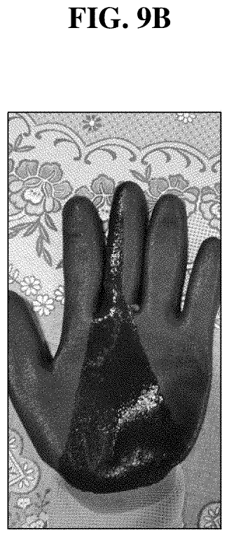

FIG. 9 illustrates images of gloves coated with a silicone resin, according to other comparative examples of the present disclosure. FIG. 9A illustrates the industrial glove of Comparative Example 4, and FIG. 9B illustrates the industrial glove of Comparative Example 5.

Referring to FIG. 9A, it can be seen that in the case of the industrial glove of Comparative Example 4 including the first coating film including polyurethane, a coating film formed of a silicone resin and formed on the outer surface of the glove has a uniform thickness. However, unlike the industrial glove of Preparation Example 1, the polyurethane is unable to have water solubility, and then it can be seen that the silicone resin is separated from the polyurethane coating film. That is, the coating film including a silicone resin has weak durability.

Referring to FIG. 9B, in the case of the industrial glove of Comparative Example 5 including rubber such as NBR in the first coating film, the NBR rubber on the surface of the glove may react with the silicone resin, and thus the silicone resin is not cured and is unable to form a coating film.

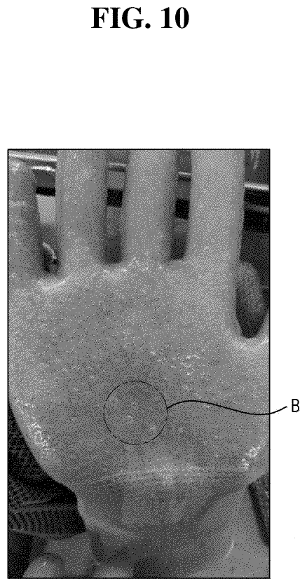

FIG. 10 is an image illustrating a glove coated with a silicone resin, on which a defoaming process has not been performed, according to a comparative example of the present disclosure. FIG. 10 illustrates an outer surface of the industrial glove of Comparative Example 6.

Referring to FIG. 10, it can be seen that in the case of the industrial glove of Comparative Example 6, air bubbles included in the silicone resin composition are not removed when forming a coating film, and thus are exposed at the surface. As illustrated in portion B of FIG. 10, air bubbles included in the silicone resin composition are directly formed on the surface of the industrial glove. These air bubbles reduce the elongation and durability of the coating film formed of a silicone resin. Thus, to form a coating film formed of a silicone resin without air bubbles as in Preparation Example 1, a defoaming process for removing air bubbles of the silicone resin composition is needed.

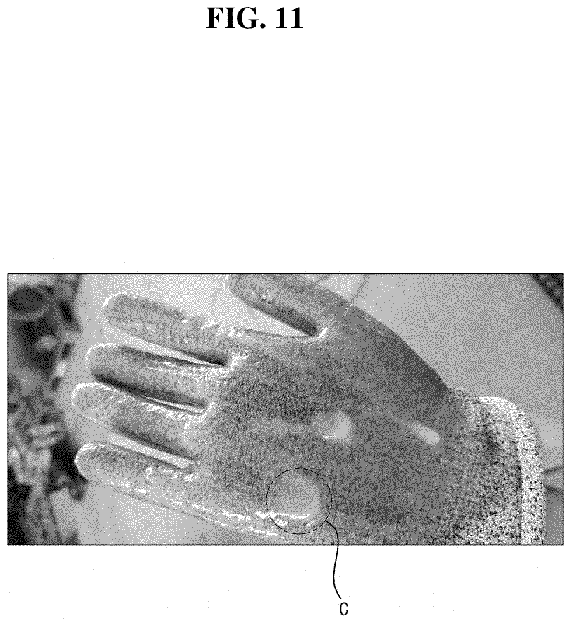

FIG. 11 is an image illustrating a glove manufactured without performing a first drying process, according to a comparative example of the present disclosure. FIG. 11 illustrates an outer surface of the industrial glove of Comparative Example 7.

Referring to FIG. 11, it can be seen that in the case of the industrial glove of Comparative Example 7, an excess amount of the silicone resin composition used in the dipping process is unable to be sufficiently removed, and thus a coating film formed on an outer surface of the glove is not uniform. As illustrated in portion C of FIG. 11, the coating film formed of the silicone resin composition has a non-uniform thickness and surface. Since the silicone resin composition has a relatively higher viscosity than the polyurea resin composition, an excess amount of a silicone resin may be used in the dipping process in a dipping machine. As in the industrial glove of Preparation Example 1, in order for a coating film formed of a silicone resin and formed on an outer surface of the glove to have a small and uniform thickness, a process of partially removing the excess amount of the silicone resin composition is needed.

When the first drying process is not performed, the second coating film formed of the excess amount of the silicone resin composition may be not uniform, and when the first drying process is performed for a long period of time, the amount of the removed silicone resin composition is too large, and thus the thickness of the second coating film becomes too small, a silicone resin is detached from finger portions of the glove, and as a result, a coating film may not be formed.

That is, in the manufacturing process of the industrial glove, the first and second drying processes of drying the silicone resin composition may be performed, thereby forming a thin silicone resin coating film on the glove.

As is apparent from the foregoing description, an industrial glove according to an embodiment of the present disclosure can include a first coating film that includes an inner film layer partially formed on an inner skin of a glove and a coating layer on an outer surface of the glove and includes a polyurea resin, and a second coating film disposed on the first coating film and including a silicone resin. That is, in the industrial glove, dual coating films including two different types of resins can be formed. Accordingly, the industrial glove of the present disclosure can have both adhesion between a glove and a resin composition and coating film formability, and by forming dual coating films, it can have heat resistance and chemical resistance.

While the present disclosure has been particularly described with reference to embodiments thereof, these embodiments are provided for illustrative purposes only and are not intended to limit the scope of the present disclosure, and it will be obvious to those of ordinary skill in the art to which the present disclosure pertains that various modifications and applications not set forth herein can be made without departing from essential characteristics of embodiments of the present disclosure. For example, each component specifically shown in the embodiments of the present disclosure may be modified. In addition, differences related to these modifications and applications should be construed as being within the scope of the present disclosure defined by the appended claims.

What is claimed is:

1. An industrial glove comprising:
a glove;
a first coating film disposed on the glove and comprising a polyurea resin; and
a second coating film disposed on the first coating film and comprising a silicone resin,
wherein the first coating film comprises: an inner film layer formed such that an inner skin of the glove is partially impregnated with at least a part of the polyurea resin, but the at least a part of the polyurea resin does not permeate into an inner surface of the glove; and a coating layer formed of the remainder of the polyurea resin on an outer surface of the glove.

2. The industrial glove of claim 1, wherein the polyurea resin has a viscosity ranging from about 100 cps to about 300 cps, and the silicone resin has a viscosity ranging from about 6,000 cps to about 15,000 cps.

3. The industrial glove of claim 2, wherein the second coating film is formed on the coating layer, and the silicone resin of the second coating film does not permeate into the inner skin of the glove due to the coating layer.

4. The industrial glove of claim 2, wherein the polyurea resin comprises:
about 15 parts by weight to about 17.5 parts by weight of a polyol;
about 0.5 part by weight to about 1.5 parts by weight of a dispersant;
about 4.5 parts by weight to about 6.5 parts by weight of a first monomer;
and about 1 part by weight to about 2 parts by weight of a second monomer.

5. The industrial glove of claim 4, wherein the dispersant comprises dimethylolpropionic acid (DMPA), the first monomer comprises methylene diphenyl diisocyanate (MDI) or isophorone diisocyanate (IPDI), and the second monomer comprises triethanolamine (TEA) or piperazine.

6. A method of manufacturing an industrial glove, the method comprising:
preparing a polyurea resin composition and a silicone resin composition;
forming a first coating film comprising a polyurea resin on a glove by dipping the glove in the polyurea resin composition; and
forming a second coating film including a silicone resin on the first coating film by dipping the glove with the first coating film formed thereon in the silicone resin composition.

7. The method of claim 6, wherein the polyurea resin composition has a viscosity ranging from about 100 cps to about 300 cps, and the silicone resin composition has a viscosity ranging from about 6,000 cps to about 15,000 cps.

8. The method of claim 6, wherein the forming of the first coating film comprises:
heating the polyurea resin composition to a temperature ranging from about 30° C. to about 50° C.;
dipping the glove in the polyurea resin composition;
and drying the glove dipped in the polyurea resin composition at a temperature ranging from about 70° C. to about 120° C. for about 60 minutes to about 120 minutes.

9. The method of claim 6, wherein the forming of the second coating film comprises:
a defoaming process for removing air bubbles included in the silicone resin composition in a vacuum;
a dipping process of dipping the glove with the first coating film formed thereon in the defoamed silicone resin composition;
a first drying process of drying the glove dipped in the silicone resin composition after the glove has been disposed such that the glove faces a first direction to remove at least a part of the silicone resin composition;
and a second drying process of drying the glove after the glove has been disposed such that the glove faces a second direction, the second direction being different from the first direction.

10. The method of claim 9, wherein the first drying process is performed for about 10 minutes to about 30 minutes.

11. The method of claim 9, wherein the second drying process is performed at a temperature ranging from about 80° C. to about 120° C. for about 10 minutes to about 60 minutes.
